(19) United States
(12) Patent Application Publication
(10) Pub. No.: US 2020/0158446 A1
(43) Pub. Date: May 21, 2020

(54) INTERNALLY ENHANCED HEAT EXCHANGER TUBE

(71) Applicant: Carrier Corporation, Palm Beach Gardens, FL (US)

(72) Inventors: Abbas A. Alahyari, Glastonbury, CT (US); Jack L. Esformes, Jamesville, NY (US); Miad Yazdani, South Windsor, CT (US)

(21) Appl. No.: 16/613,036

(22) PCT Filed: May 11, 2018
(86) PCT No.: PCT/US2018/032337

§ 371 Date: Nov. 12, 2019

Related U.S. Application Data
(60) Provisional application No. 62/505,410, filed on May 12, 2017.

(51) Int. Cl. F28F 1/40; F28F 13/18; B23P 15/26

(52) U.S. Cl. CPC F28F 1/40; F28F 2215/10; B23P 15/26; F28F 13/187

(57) ABSTRACT

A heat transfer tube for a heating, ventilation, air conditioning and refrigeration system includes an inner tube surface defining an interior of the heat transfer tube, a plurality of first fins extending from the inner tube surface inwardly into the interior of the heat transfer tube defining a plurality of first grooves between adjacent first fins, and a plurality of second fins extending from the first fins, defining a plurality of second grooves between adjacent second fins, and defining a plurality of reentrant cavities at the first grooves, beneath the second fins.

### BACKGROUND

Exemplary embodiments pertain to the art of heat exchangers, and more particularly to heat transfer tubes for heat exchangers.

Heat exchangers typically utilize heat transfer tubes to flow a heat transfer fluid therethrough, in which the heat transfer fluid may be boiled during the heat transfer process. To enhance the boiling and heat transfer, the heat transfer tubes often include microfins in the interior of the heat transfer tube, which extend axially or helically along a length of the heat transfer tube. Further, such features may be also be applied to an exterior surface of the heat transfer tube. In some instances, such features on the exterior surface may be mechanically deformed to create re-entrant sub-surface channels and pores. Such re-entrant channels are useful in pool boiling configurations, in which the heat transfer tubes are submerged in a pool of fluid.

### BRIEF DESCRIPTION

In one embodiment, a heat transfer tube for a heating, ventilation, air conditioning and refrigeration system includes an inner tube surface defining an interior of the heat transfer tube, a plurality of first fins extending from the inner tube surface inwardly into the interior of the heat transfer tube defining a plurality of first grooves between adjacent first fins, and a plurality of second fins extending from the first fins, defining a plurality of second grooves between adjacent second fins, and defining a plurality of reentrant cavities at the first grooves, beneath the second fins.

Additionally or alternatively, in this or other embodiments the plurality of first fins extend in one of an axial direction or a helical direction along a tube length of the heat transfer tube.

Additionally or alternatively, in this or other embodiments the plurality of second fins extend in the other of an axial direction or the helical direction along a tube length of the heat transfer tube.

Additionally or alternatively, in this or other embodiments both the plurality of first fins and the plurality of second fins extend in helical directions along a tube length of the heat transfer tube.

Additionally or alternatively, in this or other embodiments the plurality of first fins and the plurality of second fins extend in opposing helical directions along the tube length.

Additionally or alternatively, in this or other embodiments the plurality of second fins is formed by a mechanical deformation of the plurality of second fins.

Additionally or alternatively, in this or other embodiments each of the plurality of first fins and the plurality of second fins have a height in the range of 10 microns to 800 microns.

Additionally or alternatively, in this or other embodiments the tube is formed from a first material and the plurality of second fins are formed from a second material different from the first material.

Additionally or alternatively, in this or other embodiments the plurality of second fins are formed from a polymer or a thermally-enhanced polymer.

In another embodiment, a heating, ventilation, air conditioning and refrigeration system includes one or more heat exchangers having one or more heat transfer tubes disposed therein. The one or more heat transfer tubes are configured to exchange thermal energy between a first fluid flowing through an interior of the heat transfer tubes and a second fluid flowing over an exterior of the heat transfer tubes. Each heat transfer tube includes an inner tube surface defining the interior of the heat transfer tube, a plurality of first fins extending from the inner tube surface inwardly into the interior of the heat transfer tube defining a plurality of first grooves between adjacent first fins, and a plurality of second fins extending from the first fins, defining a plurality of second grooves between adjacent second fins, and defining a plurality of reentrant cavities at the first grooves, beneath the second fins.

Additionally or alternatively, in this or other embodiments the plurality of first fins extend in one of an axial direction or a helical direction along a tube length of the heat transfer tube.

Additionally or alternatively, in this or other embodiments the plurality of second fins extend in the other of an axial direction or the helical direction along a tube length of the heat transfer tube.

Additionally or alternatively, in this or other embodiments both the plurality of first fins and the plurality of second fins extend in helical directions along a tube length of the heat transfer tube.

Additionally or alternatively, in this or other embodiments the heat exchanger is condenser or an evaporator.

In yet another embodiment, a method of forming a heat transfer tube for a heat exchanger includes forming the heat transfer tube having a plurality of first fins extending from an inner surface of the heat transfer tube, the plurality of first fins defining a plurality of first grooves between adjacent first fins, and forming a plurality of second fins extending from the first fins defining a plurality of second grooves between adjacent second fins, and defining a plurality of reentrant cavities at the first grooves, beneath the second fins.

Additionally or alternatively, in this or other embodiments forming the heat transfer tube having the plurality of first fins includes forming the plurality of first fins on a piece of flat stock material, and rolling the stock material into a tubular shape.

Additionally or alternatively, in this or other embodiments the plurality of second fins are formed by deforming at least a portion of the plurality of first fins.

Additionally or alternatively, in this or other embodiments at least a portion of the plurality of first fins are deformed via a tube expansion process.

Additionally or alternatively, in this or other embodiments the plurality of first fins are formed by extruding the plurality of first fins.

Additionally or alternatively, in this or other embodiments the plurality of second fins are formed separate and distinct from the plurality of first fins, and the plurality of second fins are secured to the plurality of first fins.

### BRIEF DESCRIPTION OF THE DRAWINGS

The following descriptions should not be considered limiting in any way. With reference to the accompanying drawings, like elements are numbered alike:

FIG. 1 is schematic view of an embodiment of a heating, ventilation, air conditioning and refrigeration (HVAC&R) system;

FIG. 2 is a cross-sectional view of an embodiment of a heat transfer tube for an HVAC&R system;

FIG. 3 is a perspective view of an embodiment of a heat transfer tube for an HVAC&R system;

FIG. 4 is a schematic view of a process for forming a heat transfer tube for an HVAC&R system; and

FIG. 5 is a schematic view of another process for forming a heat transfer tube for an HVAC&R system.

### DETAILED DESCRIPTION

A detailed description of one or more embodiments of the disclosed apparatus and method are presented herein by way of exemplification and not limitation with reference to the Figures.

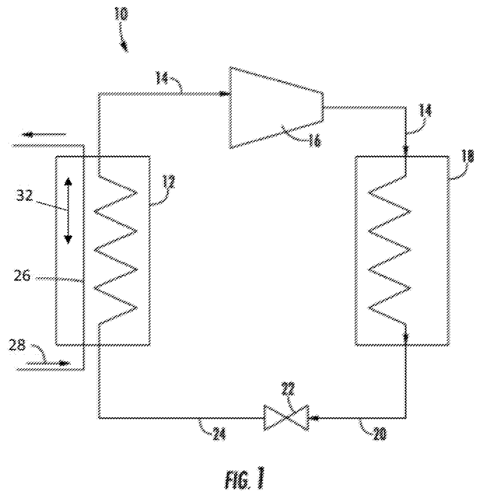

Shown in FIG. 1 is a schematic view an embodiment of a heating, ventilation, air conditioning and refrigeration (HVAC&R) system 10, for example, a chiller. It is to be appreciated, however, that the present disclosure may be utilized in other types of HVAC&R systems 10 or other systems where thermal energy transfer is accomplished utilizing heat transfer tubes. A flow of vapor first heat transfer fluid 14, for example, a refrigerant, brine solution or water, is directed into a compressor 16 and then to a condenser 18 that outputs a flow of liquid first heat transfer fluid 20 to an expansion valve 22. The expansion valve 22 outputs a vapor and liquid first heat transfer fluid mixture 24 toward an evaporator 12. The evaporator 12 includes a plurality of heat transfer tubes 26 located therein, through which a second heat transfer fluid 28 is circulated. The second heat transfer fluid 28 is cooled via thermal energy transfer with the flow of refrigerant at the evaporator 12.

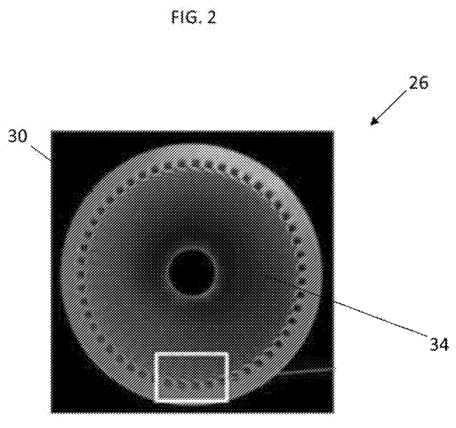

Referring now to FIG. 2, the heat transfer tubes 26 include an outer surface 30, defining an outer extent of the heat transfer tube 26, with the outer surface 30 extending continuously along a tube length 32, as shown in FIG. 1. Referring again to FIG. 2, in some embodiments the heat transfer tube 26 is substantially circular in cross-section, while in other embodiments other cross-sectional shapes, such as oval or elliptical may be utilized. The heat transfer tube 26 defines a tube interior 34 through which second heat transfer fluid 28 flows.

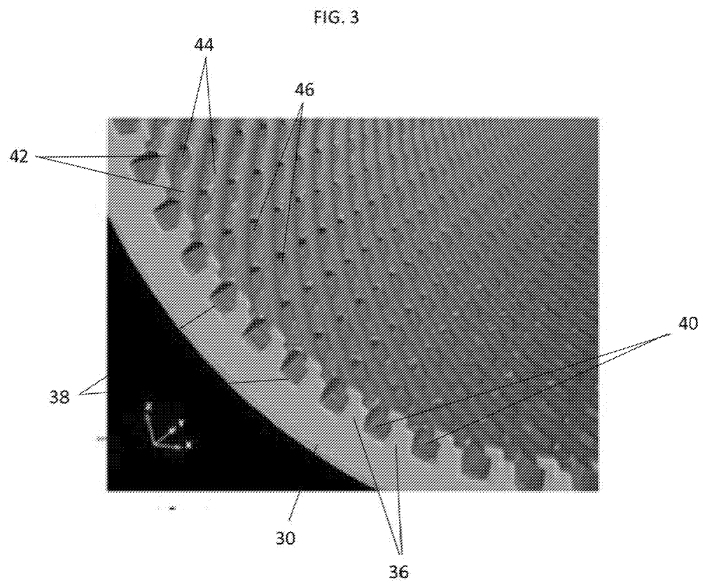

The heat transfer tube 26 is enhanced in the tube interior 34 to improve the heat transfer capability of the heat transfer tube 26. The enhancement of the heat transfer tube 26 includes a plurality of intersecting and overlaying fins defining a plurality of channels between fins. For example, as shown in FIG. 3, a plurality of first fins 36 extend inwardly from an inner tube surface 38 defining first grooves 40 between adjacent first fins 36. In some embodiments, such as shown in FIG. 3, the first fins 36 extend inwardly in a radial direction from the inner tube surface 38, and axially along the tube length 32. In other embodiments, the first fins 36 may extend in other directions, for example, helically along the tube length 32 or circumferentially around the inner tube surface 38. A plurality of second fins 42 extend from the first fins 36, defining a plurality of second grooves 44 between adjacent second fins 42. The second fins 42 are arranged to intersect or cross the first fins 36, defining a plurality of reentrant cavities 46 at the first grooves 40, beneath the second fins 42.

In the embodiment shown in FIG. 3, the first fins 36 extend in the axial direction, and the second fins 42 extend helically along the tube length 32 to intersect the first fins 36. In other embodiments, however, the first fins 36 and the second fins 42 may extend in other directions. For example, both the first fins 36 and the second fins 42 may extend helically along the tube length 32; or the first fins 36 may extend helically while the second fins 42 extend axially along the tube length 32; or the first fins 36 may extend axially along the tube length 32 while the second fins 42 extend in a circumferential direction; or the second fins 42 may extend axially along the tube length 32 while the first fins 36 extend in the circumferential direction. In some embodiments, each of the first fins 36 and the second fins 42 may have a height in the range of 10 microns to 800 microns, while in other embodiments each of the first fins 36 and the second fins 42 may have a height in the range of 50 microns to 500 microns, while in still other embodiments each of the first fins 36 and the second fins 42 may have a height in the range of 100 microns to 300 microns.

Further, while in some embodiments the first fins 36 and the second fins 42 may have the same heights, in other embodiments the heights of the first fins 36 may differ from the heights of the second fins 42. For example, in some embodiments the heights of the first fins 36 may be greater than the heights of the second fins 42, while in other embodiments the heights of the second fins 42 may be greater than the heights of the first fins 36. In still other embodiments, the first fins 36 may be all of equal height, while in other embodiments the height of the first fins 36 may vary depending on, for example, axial or circumferential location within the heat transfer tube 26.

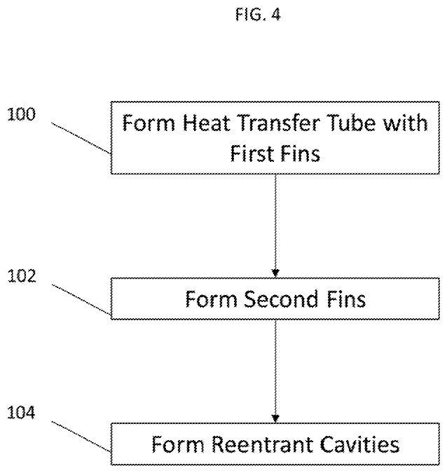

Referring now to FIG. 4, one or more methods may be utilized to form the present heat transfer tubes 26. In the method of FIG. 4, heat transfer tubes 26 are first formed with first fins 36 at block 100. In some embodiments, the first fins 36 are formed by, for example, an extrusion process together with the heat transfer tube 26. Once first fins 36 are formed, one or more operations are performed on the first fins 36 to deform the first fins 36 at block 102. The deformation of the first fins 36 results in the formation of second fins 42 and the formation of the reentrant cavities 46 via the deformation at block 104. In some embodiments, the deformation of the first fins 36 is performed during a tube expansion process. In such embodiments, where the second fin 42 is formed from deformation of the first fin 36, the pre-deformation height of the first fin 36 may be in the range of, for example, 400-1000 microns.

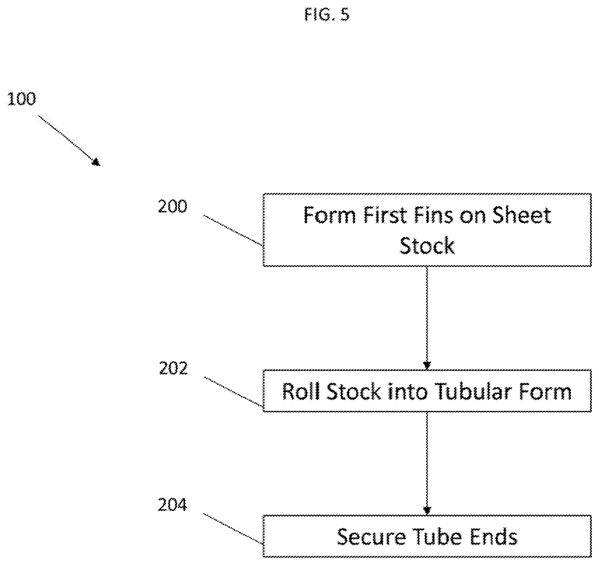

In some embodiments, the forming of heat transfer tubes 26 with first fins 36 may include, as shown in FIG. 5, forming the first fins 36 onto flat sheet stock at block 200, then the sheet stock is rolled into a tubular shape at block 202. Finally, the ends to the sheet stock are secured into the tubular shape at block 204 via, for example, brazing or welding.

In other embodiments, the second fins are separate elements secured to the first fins 36 by, for example, brazing or other process. In other embodiments, the heat transfer tubes 26 may be formed utilizing an additive manufacturing process.

In some embodiments, the heat transfer tube 26 is formed from a first material and the plurality of second fins 42 are formed from a second material different from the first material. In some embodiments, the plurality of second fins 42 are formed from a polymer or a thermally-enhanced polymer.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the an that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A heat transfer tube for a heating, ventilation, air conditioning and refrigeration system, comprising:
an inner tube surface defining an interior of the heat transfer tube;
a plurality of first fins extending from the inner tube surface inwardly into the interior of the heat transfer tube defining a plurality of first grooves between adjacent first fins; and
a plurality of second fins extending from the first fins, defining a plurality of second grooves between adjacent second fins, and defining a plurality of reentrant cavities at the first grooves, beneath the second fins.

2. The heat transfer tube of claim 1, wherein the plurality of first fins extend in one of an axial direction or a helical direction along a tube length of the heat transfer tube.

3. The heat transfer tube of claim 2, wherein the plurality of second fins extend in the other of an axial direction or the helical direction along a tube length of the heat transfer tube.

4. The heat transfer tube of claim 1, wherein both the plurality of first fins and the plurality of second fins extend in helical directions along a tube length of the heat transfer tube.

5. The heat transfer tube of claim 4, wherein the plurality of first fins and the plurality of second fins extend in opposing helical directions along the tube length.

6. The heat transfer tube of claim 1, wherein the plurality of second fins is formed by a mechanical deformation of the plurality of second fins.

7. The heat transfer tube of claim 1, wherein each of the plurality of first fins and the plurality of second fins have a height in the range of 10 microns to 800 microns.

8. The heat transfer tube of claim 1, wherein the tube is formed from a first material and the plurality of second fins are formed from a second material different from the first material.

9. The heat transfer tube of claim 1, wherein the plurality of second fins are formed from a polymer or a thermally-enhanced polymer.

10. A heating, ventilation, air conditioning and refrigeration system including one or more heat exchangers having one or more heat transfer tubes disposed therein, the one or more heat transfer tubes configured to exchange thermal energy between a first fluid flowing through an interior of the heat transfer tubes and a second fluid flowing over an exterior of the heat transfer tubes, each heat transfer tube including:
an inner tube surface defining the interior of the heat transfer tube;
a plurality of first fins extending from the inner tube surface inwardly into the interior of the heat transfer tube defining a plurality of first grooves between adjacent first fins; and
a plurality of second fins extending from the first fins, defining a plurality of second grooves between adjacent second fins, and defining a plurality of reentrant cavities at the first grooves, beneath the second fins.

11. The heating, ventilation, air conditioning and refrigeration system of claim 10, wherein the plurality of first fins extend in one of an axial direction or a helical direction along a tube length of the heat transfer tube.

12. The heating, ventilation, air conditioning and refrigeration system of claim 11, wherein the plurality of second fins extend in the other of an axial direction or the helical direction along a tube length of the heat transfer tube.

13. The heating, ventilation, air conditioning and refrigeration system of claim 10, wherein both the plurality of first fins and the plurality of second fins extend in helical directions along a tube length of the heat transfer tube.

14. The heating, ventilation, air conditioning and refrigeration system of claim 10, wherein the heat exchanger is condenser or an evaporator.

15. A method of forming a heat transfer tube for a heat exchanger, comprising:
forming the heat transfer tube having a plurality of first fins extending from an inner surface of the heat transfer tube, the plurality of first fins defining a plurality of first grooves between adjacent first fins; and
forming a plurality of second fins extending from the first fins defining a plurality of second grooves between adjacent second fins, and defining a plurality of reentrant cavities at the first grooves, beneath the second fins.

16. The method of claim 15, wherein forming the heat transfer tube having the plurality of first fins comprises:
forming the plurality of first fins on a piece of flat stock material; and
rolling the stock material into a tubular shape.

17. The method of claim 15, further comprising forming the plurality of second fins by deforming at least a portion of the plurality of first fins.

18. The method of claim 17, further comprising deforming at least a portion of the plurality of first fins is performed via a tube expansion process.

19. The method of claim 1S, further comprising forming the plurality of first fins by extruding the plurality of first fins.

20. The method of claim 15, further comprising:
forming the plurality of second fins separate and distinct from the plurality of first fins; and
securing the plurality of second fins to the plurality of first fins.
